(19) United States
(12) Patent Application Publication
(10) Pub. No.: US 2004/0148824 A1
(43) Pub. Date: Aug. 5, 2004

(54) Personal medical calendar and method of use

(76) Inventors: Janis A. Nein, Pelham, NH (US); John G. Nein, Pelham, NH (US)

Correspondence Address: MESMER & DELEAULT, PLLC, 41 BROOK STREET, MANCHESTER, NH, 03104, US

(21) Appl. No.: 10/355,608

(22) Filed: Jan. 31, 2003

(51) Int. Cl. G09D 3/04

(52) U.S. Cl. 40/119

(57) ABSTRACT

A personal medical calendar has a plurality of sheets where each sheet has calendar indicia on one side thereof and an informational form disposed on the other side for recording various medical related information, a front cover having an inside surface with a medical form disposed thereon for recording personal medical history information particular to a user, and a back cover where the plurality of sheets, the front cover and the back cover are connected to each other with a joining structure along one edge thereof. The personal medical calendar includes a medical event indicia key.

### BACKGROUND OF THE INVENTION

1. Field of the Invention

The present invention relates generally to calendars. Particularly, the present invention relates to calendars for reminding a person of particular events. More particularly, the present invention relates to calendars and organizers specific for reminding a person of medical events.

2. Description of the Prior Art

Wall calendars usually encompass one year by having twelve pages, one page for each month. Each page is divided by vertical lines into seven columns that correspond to the seven days of the week. The seven columns are subsequently divided by horizontal lines into five rows that create squares of space to denote the individual days in the month.

Calendars have been used to record seasons and moon phases associated with agricultural events such as plowing, planting, watering, and harvesting. Calendars have also been used to follow animal and plant activities and to hunt and gather berries, nuts, and fuel wood during the appropriate seasons.

In addition to these uses, wall calendars are now well known in the art for determining social dates and whether or not a social event is supposed to occur on a given day. People use calendars to record religious holidays, national or bank holidays, birthdays, anniversaries, vacations, and many other social celebrations. People also use calendars to write personal events for a given day within the space delineated for that given day. Personal events recorded on a calendar may be social, business, or medical. A social event to be recorded in the space for a particular day could either be a meal at a particular restaurant at a particular time or a haircut appointment at a particular hair salon at a particular time. A business event to be recorded in the space for a particular day could be the time and location of a banking event, such as an appointment for obtaining a loan. A medical event to be recorded in the space for a particular day could be the time to take a medication or the time of a medical appointment.

Often, individuals that have a medical condition must take medications every day. Other individuals, especially the older generation, must take more than one medication each day for differing medical conditions, where each medication is to be administered several times a day at differing intervals. As the number of medications to be administered each day increases, it becomes more and more difficult to remember the given dosages at the given times. The prior art attempts to address the problem of coordination of daily medication. Calendars for organizing and reminding individuals to take medications at pre-determined times have been disclosed.

U.S. Pat. No. 3,099,352 discloses a calendar and dispenser device. The device contemplates a combination of a base or support member, having indicated thereon by printing, or otherwise, a series of adjoining serially numbered spaces, such as a weekly or monthly calendar, to which containers holding the pills or capsules are affixed so as to cover the spaces during which the medicine is to be consumed. Preferably the containers are individual pockets, or in strip form having weakened zones which permit tearing away one dose at a time when each dosage is torn away and consumed, and indicating when the next dosage is to be taken.

U.S. Pat. No. 4,905,388 discloses an organizer and reminder device for pills, medicines, and the like. The organizer and reminder device is generally presented in a calendar format to remind the user to take certain pills, medicines, etc. on indicated days of the month. It provides a plurality of containers secured on a mounting panel through windows representative of days of the month and formed in a plurality of stacked sheets. Each sheet is representative of a different month of the calendar year and an exposed one of the stacked sheets is representative of a current month. One or more pills, medicines, etc. to be taken on a given day of the month are located in an appropriately positioned container.

Although the prior art has addressed the organization and scheduling of daily dosages of multiple medications, a system for recording medical events has not been addressed. Medically-pertinent events become especially important to remember once an individual begins to have multiple health conditions and begins to see multiple health-care physicians, one for each condition. Each of these physicians may need the patient's past medical history for the given condition to be treated, the patient's current symptoms, and whether or not the patient has had necessary tests performed. If these historical medical events are not recorded and the patient cannot recall these events, the patient can either miss the appointment entirely or render the appointment non-productive.

Older individuals may have difficulty recording medically-pertinent events because they have difficulty with hand and finger coordination due to joint conditions and cannot easily manipulate a writing instrument for recording all of the details of a given medical appointment. Even if the older individual can record a medical event or has a personal assistant to record the event for them, the event can be missed because the individual cannot see the recordation clearly and will not be able to determine what is to take place on a given day.

Therefore, what is needed is a medical calendar for recording forthcoming medical events that is easy to manipulate for the hand-afflicted individual. What is also needed is a system for recording forthcoming medical events that has easily visible event indications. What is further needed is a method of visibly differentiating between medical event indications. What is also needed is a system for recording past medical history. What is still further needed is a system for keeping both forthcoming medical events as well as past medical history in one location. What is yet further needed is a portable system for recording indications of medical events that can be taken to medical personnel for their viewing.

### SUMMARY OF THE INVENTION

It is an object of the present invention to provide a system for recording forthcoming medical events that is easy to manipulate for the hand-afflicted individual. It is another object of the present invention to provide a system for recording forthcoming medical events that has easily visible event indicators. It is a further object of the present invention to provide a system for visibly differentiating between medical event indicators. It is still further an object of the present invention to provide a system for recording past medical history. It is even further an object of the present invention to provide a system of indicating both present and forthcoming medical events as well as past medical history. It is yet another object of the present invention to provide a portable system for recording various medical data including past, present, and future medical events that can be taken to one's personal healthcare providers for their viewing.

The present invention achieves these and other objectives by providing a personal medical calendar having a plurality of sheets, a front cover, and a back cover. The front of each sheet within the plurality of sheets outlines a particular month. The front of each monthly sheet is divided into seven columns denoting the seven days of the week and five rows denoting the maximum number of weeks in a month. The columns and rows form squares of space that are numbered to indicate the individual days within the given month. When a medical event is to occur on a given individual day, an indicator denoting that particular medical event can be placed within the square for that day.

Medical calendars may also be customized for particular medical afflictions or conditions. These customized calendars would include daily spaces with locations for writing additional specific information pertinent to that given medical affliction. For example, calendars customized for the heart condition of hypertension would include daily spaces with locations for recording daily blood pressure and pulse rate; calendars customized for diabetes would include daily spaces with locations for recording one or more daily blood sugar levels while fasting and at additional random times of measurement.

Once a given month on the calendar has passed, that monthly sheet is to be folded upward and secured such that the back of that sheet is visible above the new month. The back of each monthly sheet contains locations for recording medical instructions, medical questions or concerns, or other miscellaneous medical information for that new month. Possible medical instructions to be recorded would include instructions for taking medications or indications for performing certain medical events. For example, instructions for taking certain medications could be that a particular medication must be taken either before or after eating or at bedtime. As additional examples, indications for performing certain medical events could be that urine or stool specimens should be brought to a given medical appointment; that laboratory tests should be performed at regular time intervals; or, that ice or heat or a medicated ointment should be placed upon an affected body part if a certain symptom recurs.

Medical questions or concerns that could be recorded on the back of each monthly sheet could be questions regarding whether a given symptom is due to a particular medical condition or not, whether a given medication should or should not be refilled, or whether certain medications should be administered together or not.

Other miscellaneous medical information that could be recorded includes additional medical instructions, indications, questions or concerns where additional space is needed.

The outside front cover of the calendar lists the year or years corresponding to the plurality of monthly sheets included inside the medical calendar. Locations for recording the calendar user's name, address, and telephone number can occur on the outside front cover, but may occur elsewhere within the calendar to maintain the privacy of the user's medical information. The inside front cover of the calendar has locations for recording the user's medical information. Medical information that could be listed on the inside front cover includes the user's current body weight; height; blood type; a list of current prescription and non-prescription medications and dosages; known allergies; dates of last vaccinations; dates of last diagnostic tests; past surgeries; and, family histories of illnesses or health conditions.

The outside back cover of the calendar may contain locations for recording the user's name, address and telephone number. The inside back cover provides one or more locations for recording of important medical telephone numbers, a medical event indicator key, and a storage pocket. Important medical telephone numbers may include telephone numbers corresponding to a particular pharmacy, a particular home health care nurse, physician's office, hospital, or ambulance service. A medical indicator key outlines a list of differing symbols and the defined medical event that corresponds to each differing symbol. Symbols can differ based upon shape, color, or a combination of shape and color.

A storage pocket may be provided on the inside back cover of the calendar for containing medical papers, medical event indicator sheets or medical event indicator marker packs. Important medical papers that can be placed inside the storage pocket may include prescriptions that need to be filled at a later date or medical laboratory testing orders that are to be performed on the user at a later date. Medical event indicator sheets contain adhesive-backed indicator symbols that differ in shape, color, or a combination of shape and color and correspond to the symbols for medical events as defined in the medical event indicator key. Medical event indicator marker packs, for use along with or instead of medical event indicator sheets, contain markers of varying color that correspond to the colors of the symbols for medical events as defined in the medical event indicator key.

To initially use the personal medical calendar, a user or a user's aide would complete the user's name, address and telephone number followed by the user's medical information. If certain medical information isn't available, that medical information should be sought out and recorded within the given locations on the calendar when found. Once the past medical information is completed, the medical calendar only needs to be updated as medical events occur.

When future medical events need to be scheduled, the user or the user's aide looks at the medical indicia key and locates the symbol that defines the particular medical event at issue. The indicia applicator, a sheet of colored adhesive shapes, is retrieved from the storage pocket located within the inside surface of the back cover of the calendar. The correct colored adhesive shape that is pertinent to the medical event is chosen from among the group. The correct colored adhesive shape is removed from the non-stick sheet and placed within the square that indicates the day of the month that the medical event will occur. An ink pen can then be used to record additional information within the square or actually on the colored adhesive shape that is pertinent to the medical event.

For example, a laboratory blood test needs to be scheduled on the 15^{th} day of every month, from January through June. The medical indicia key defines a red circle shape as an indicator of a laboratory blood test. Sheets of colored indicator shapes are retrieved from the storage pocket on the inside of the back cover of the calendar. Six red circles are needed to correspond to the six months of January to June. A red circle is peeled from the sheet of indicator shapes and placed on the daily square for the 15^{th} day of January. An ink pen is used to record the time of the January 15^{th} appointment above the red circle shape as 2 pm. This process is repeated for the laboratory appointments occurring on the 15^{th} day for the months of February through June with the colored adhesive shapes for each appointment being removed one at a time to preserve the adhesive. If colored adhesive shapes are contra-indicated, then a red marking pen may be used as the desired indicia applicator for drawing and filling in a red circle to indicate a laboratory appointment on the desired dates.

Once the scheduling of the six laboratory appointments is complete, the indicia applicators, either the colored indicator shapes or the colored marking pens, are replaced within the storage pocket on the inside back cover for later use in scheduling other medical events.

The present invention can be taken to appointments with healthcare providers by the user/patient. It provides a handy and convenient way for nurses, physician's assistants and/or the Doctor to have the patient's specific medical-related data such as past and present problems, family history, medicines being taken, allergies, dates of last exams and/or medical tests, etc. This is extremely helpful with older patients who may have forgotten some of their specific information.

### BRIEF DESCRIPTION OF THE DRAWINGS

FIG. 1 is a perspective view of one embodiment of the personal medical calendar of the present invention.

FIG. 2 is a plan view of the inside front cover showing locations for recording personal health history.

FIG. 3 is a plan view of the back surface of one monthly sheet with locations for recording personal health instructions, and questions.

FIG. 4 is a plan view of the front surface of one monthly sheet.

FIG. 5 is a plan view of the inside back cover illustrating the indicia key.

FIG. 6 is a perspective view of another embodiment of the present invention.

### DETAILED DESCRIPTION OF THE PREFERRED EMBODIMENT

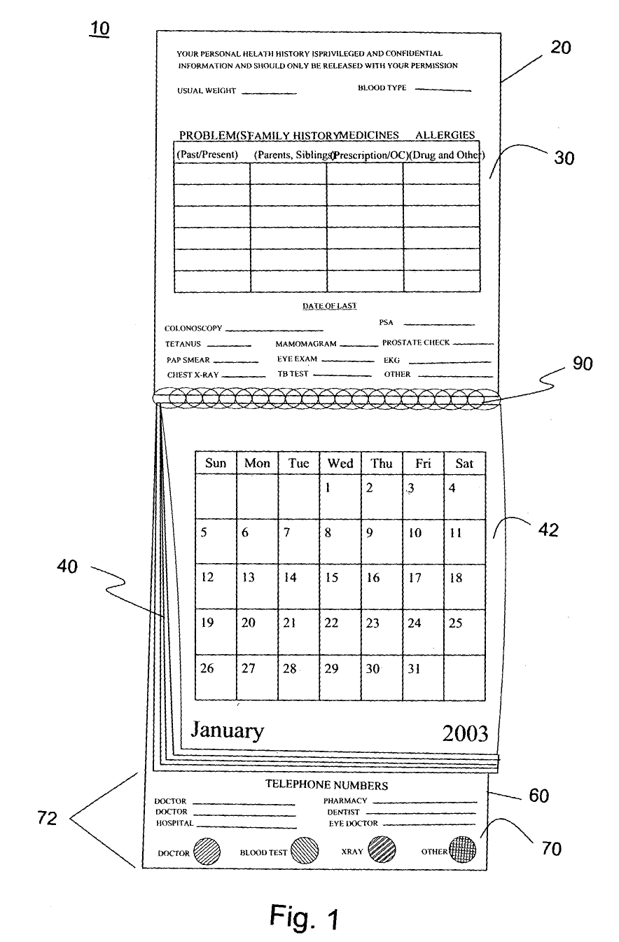

The preferred embodiment of the present invention is illustrated in FIGS. 1-5. FIG. 1 is a perspective view of the personal medical calendar 10. Medical calendar 10 has a front cover 20, a plurality of sheets 40, a back cover 60, and a joining structure 90. The plurality of sheets 40 each have a front sheet surface 42 that represents the months of the year, preferably one month per front sheet surface 42, and a back sheet surface 50 (not shown). Each sheet of the plurality of sheets 40 is coextensive with one another.

Front cover 20 has an outside front cover surface 22 (not shown) and an inside front cover surface 30. Front cover 20 is preferably coextensive with plurality of sheets 40. Back cover 60 has an outside back cover surface 62 (not shown) and an inside back cover surface 70. Preferably, back cover 60 is longer than the plurality of sheets 40 and front cover 20 such that a portion 72 of inside back cover 70 is viewable whether calendar 10 is open revealing a particular month or closed.

Joining structure 90 permanently joins the top edges of front cover 20, the plurality of sheets 40 and back cover 60 together forming a single calendar unit 10 that can be mounted on a wall or folded into a closed position. In the preferred embodiment, joining structure 90 contains a rigid spine and a plurality of curved extensions that pass through a corresponding plurality of perforations within the top edges of front cover 20, the plurality of sheets 40 and the back cover 60 of calendar 10 and curve back under the rigid spine to hold the components of calendar 10 in a pivoting relationship about joining structure 90. It should be noted that the type of joining structure 90 is not limiting. Any structural configuration that functions to keep the calendar bound as a single unit may be used. Examples are staples along the top edges, adhesive formulations, sewn seam, or a plurality of sheets where each sheet has a fold across its width dividing the sheet into approximately equal halves where each half sheet is equivalent to the monthly sheet having a front sheet surface 42 and a back sheet surface 50.

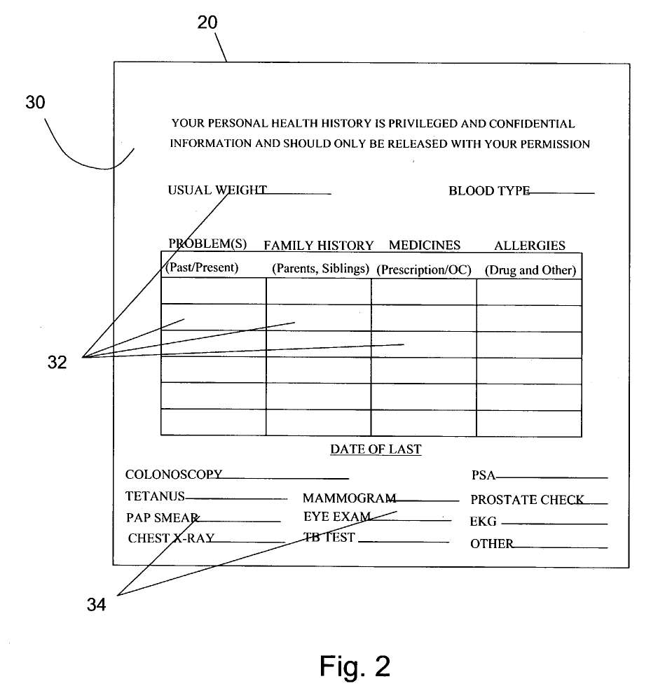

FIG. 2 is a plan view of the inside surface 30 of front cover 20. There are various spaces/locations 32 to record information about the user's personal health history. There are also spaces/locations 34 to record information about past medical testing that the user has undergone. The data may be arranged in any structure so long as it provides concise and easy to read information for the health care provider. Examples of medical information that would typically be of interest to a health care practitioner are weight, blood type, past and present patient problems, family history, medicines being taken, allergies to environmental factors as well as drugs, etc. Other medical information that may be useful to the health care practitioner is the types and dates of the last medical related exams and tests. Examples of such information include, but are not limited to, colonoscopy, PSA, tetanus, mammogram, prostate check, pap smear, eye exam, EKG, chest x-ray, TB test, etc.

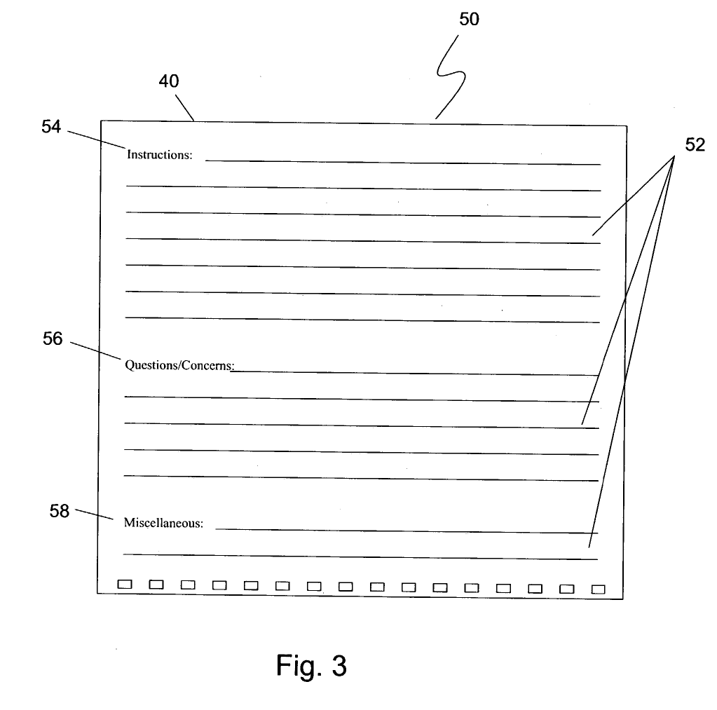

FIG. 3 is a plan view of the back sheet surface 50 of one monthly sheet 40. Back sheet surface 50 has a plurality of locations 52 for recording various other medical information. In the preferred embodiment, plurality of locations 52 includes a predefined area 54 onto which may be transcribed medical instructions that the user is to follow such as a treatment regimen until the user's next medical appointment, a predefined area 56 onto which may be transcribed questions to ask during future medical appointments, and a predefined area 58 onto which may be transcribed symptoms or other miscellaneous medical information.

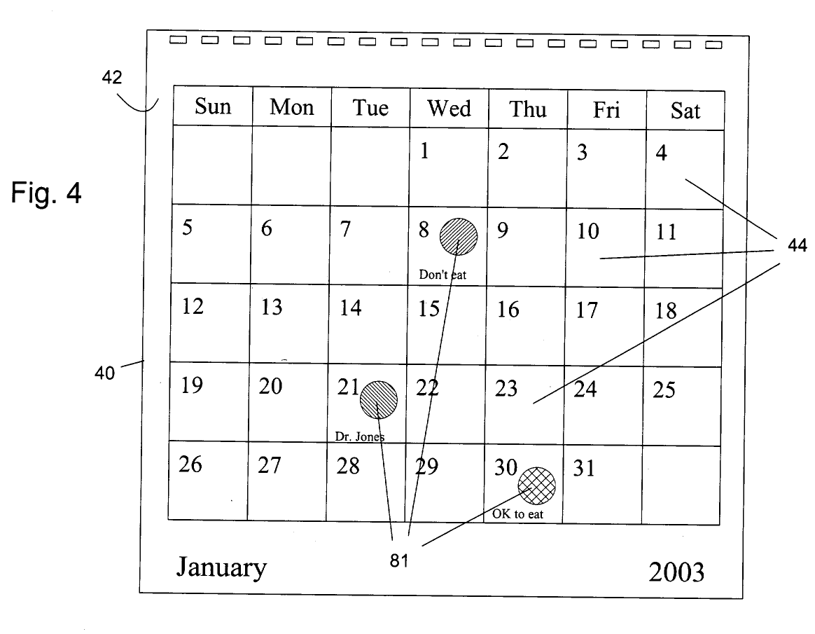

FIG. 4 is a plan view of the front sheet surface 42 of one of the plurality of sheets 40. Front sheet surface 42 has a plurality of daily spaces 44. Daily spaces 44 are used to record medical events with an indicia applicator 82. The plurality of daily spaces 44 conforms to the actual number of days within the desired month of the year represented by monthly sheet 40. Daily spaces 44 are sized to receive at least one medical event indicia 81 recorded by an indicia applicator 82. Daily spaces 44 can also be sized to accept medical results obtained from the daily medical monitoring required by a particular medical affliction. When the front sheet surface 42 of monthly sheet 40 is viewable, the medical event indicia 81 are preferably easily viewable and recognizable by the user from a distance. In the illustrated example, medical event indicia are of different colors to indicate a doctor's appointment, a blood test, an X-ray, etc.

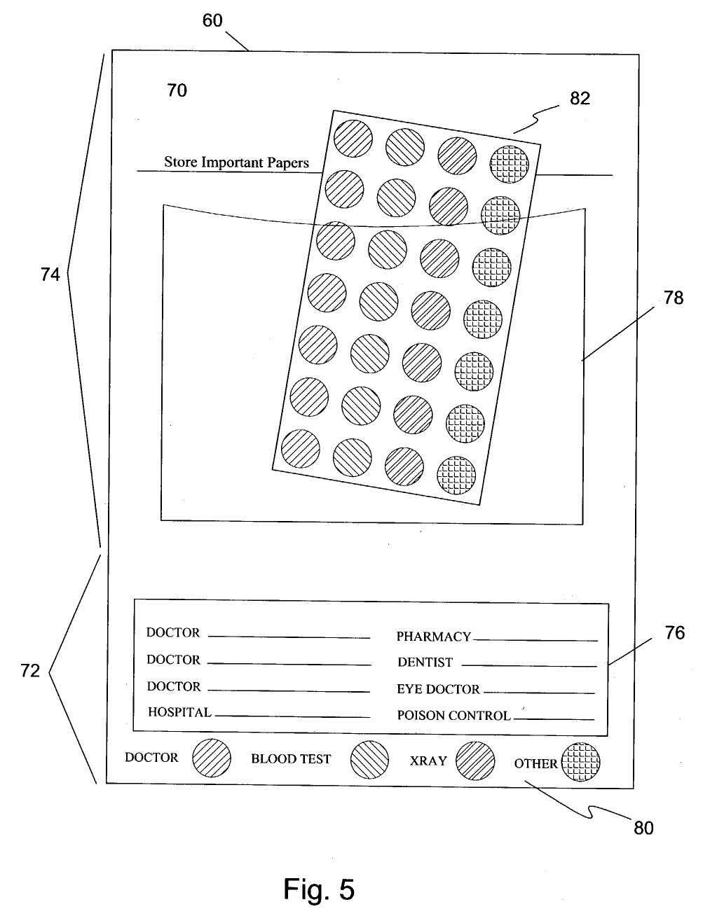

FIG. 5 is a plan view of the inside back cover surface 70 of back cover 60. Inside back cover surface 70 has a predefined smaller portion 72 and a predefined larger portion 74. Smaller portion 72 includes at least a medical event indicia key 80 to be used when recording particular medical events with an indicia applicator in the daily spaces 44 on the front sheet surface 42 of a monthly sheet 40. Other medical information 76 may also be transcribed onto predefined areas of smaller portion 72. Important medical-related telephone numbers such as, for example, doctor(s), hospital, pharmacy, dentist, eye doctor, poison control center, etc., may be recorded for easy access to these numbers.

Larger portion 74 may include a back cover pocket 78. Back cover pocket 78 is used to store a plurality of indicia applicators 82 as well as other important medical/health related papers. The preferred indicial applicators 82 are self-adhesive, colored paper/labels sized to fit within a daily space 44 on front sheet surface 42 where each color represents a particular medical event according to the medical event indicia key 80. Indicia applicators 82 may also include an area in which additional, written information such as time of the particular appointment and/or whether fasting is required.

In one embodiment of personal medical calendar 10 specific to a given medical affliction, daily spaces 44 on monthly sheets 40 may be sized and labeled to receive, in addition to indicia applicators 82, written results obtained from the required medical self-monitoring needed to manage a given medical affliction.

In the preferred method of recording a medical event destined to occur on a specific date, differing colors are defined for differing medical events within medical event indicia key 80. A plurality of color indicator shapes with adhesive backing that make up the plurality of indicia applicators 82 correspond to the plurality of colors in medical indicia key 80. The plurality of color indicator shapes is stored on non-stick paper sheets to retain their adhesive backing. In addition to or in place of color, separate and distinct shapes may be used to represent a particular type of medical event. For example, squares for doctor's appointments, circles for blood tests, triangles for X-rays, etc. An alternative to adhesive-backed shapes is the use of colored markers where each colored marker corresponds to a particular medical event in the medical indicia key 80. The colored markers are used to mark a particular daily space 44, the day on which a particular medical event is to occur. Preferably, bright contrasting colors and/or shapes are used for the plurality of indicia applicators 82. Indicia applicators 82 may also be sized to allow recording the time of the medical event or other instructions such as, for example, fasting required, etc.

When a medical event needs to be scheduled for a specific date, the correct color indicator shape is removed from the non-stick paper sheet and placed on daily space 44 of monthly sheet 40 that pertains to the date of the medical event. Non-stick paper sheets of color indicator shapes are stored in storage pocket 78 on inside back cover 60 when not in use.

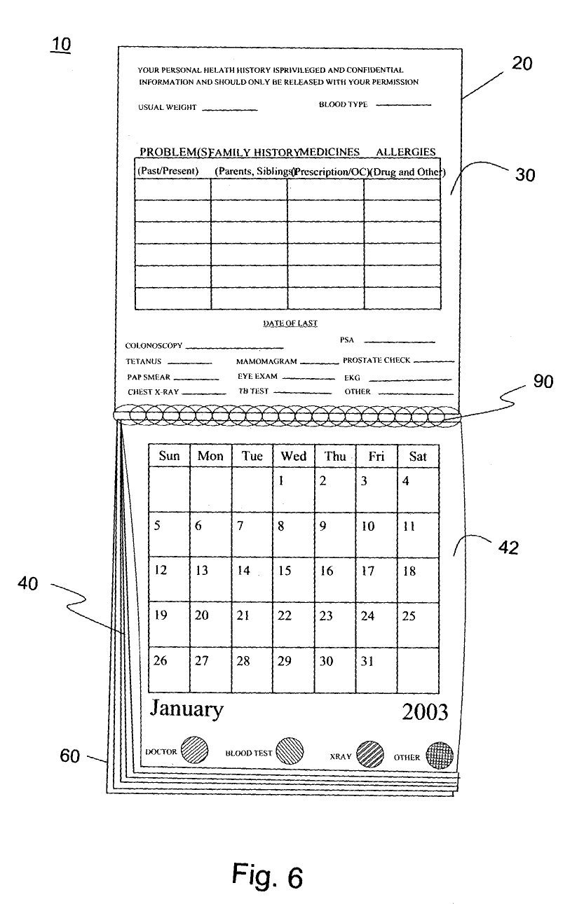

In yet another embodiment of the present invention as illustrated in FIG. 6, the medical indicia key may be incorporated on either or both front and back sheet surfaces 42 and 44 instead of on smaller portion 72 of inside back cover surface 70. In such an embodiment, back cover 60 may be coextensive with plurality of sheets 40 and front cover 20.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A personal medical calendar comprising:
a plurality of coextensive sheets wherein each of said plurality of sheets has calendar indicia on one side thereof and an informational form disposed on the other side for recording personal medical related information, wherein said calendar indicia are in chronological sequence;
a front cover having an inside surface with a medical form disposed thereon for recording personal medical history information particular to a user; and
a back cover being larger than said plurality of sheets and said front cover and exposing a portion of an inside back cover surface, said inside back cover surface containing at least a medical indicia key, said plurality of coextensive sheets, said front cover and said back cover being bound together with a joining structure along one edge thereof.

2. The personal medical calendar of claim 1 further comprising a plurality of medical indicia applicators.

3. The personal medical calendar of claim 2 wherein said plurality of medical indicia applicators comprising a plurality of adhesive shapes corresponding to said medical indicia key disposed on said inside back cover surface.

4. The personal medical calendar of claim 1 wherein said plurality of self-adhesive shapes are large enough to be distinguishable from one another when applied to said calendar indicia side of said plurality of coextensive sheets.

5. The personal medical calendar of claim 1 wherein said medical indicia key illustrates medical events indicia sufficiently different from one another to be recognizable and distinguishable from a distance.

6. The personal medical calendar of claim 5 wherein said medical events indicia are different colors.

7. The personal medical calendar of claim 1 wherein said inside back cover surface includes a pocket.

8. The personal medical calendar of claim 1 further comprising instructions for using said personal medical calendar.

9. The personal medical calendar of claim 1 wherein said front cover is substantially coextensive with said plurality of sheets.

10. A personal medical calendar comprising:
a plurality of sheets wherein each of said plurality of sheets has calendar indicia on one side thereof and an informational form disposed on the other side for recording personal medical related information, wherein said calendar indicia are in chronological sequence and wherein each of said plurality of sheets have a medical indicia key;
a front cover having an inside surface with a medical form disposed thereon for recording personal medical history information particular to a user; and
a back cover having an inside back cover surface; and
a joining structure connecting said plurality of sheets, said front cover and said back cover along one edge thereof.

11. The personal medical calendar of claim 10 further comprising a plurality of medical indicia applicators.

12. The personal medical calendar of claim 11 wherein said plurality of medical indicia applicators comprising a plurality of self-adhesive shapes corresponding to said medical indicia key.

13. The personal medical calendar of claim 10 wherein said plurality of self-adhesive shapes are large enough to be distinguishable from one another when applied to said calendar indicia side of said plurality of coextensive sheets.

14. The personal medical calendar of claim 10 wherein said medical indicia key illustrates medical events indicia sufficiently different from one another to be recognizable and distinguishable from a distance.

15. The personal medical calendar of claim 14 wherein said medical events indicia are different colors.

16. The personal medical calendar of claim 10 wherein said inside back cover surface includes a pocket.

17. The personal medical calendar of claim 10 further comprising instructions for using said personal medical calendar.

18. A method of using a personal medical calendar comprising:
gathering one or more personal medical events and personal, medical, historical information pertinent to a user;
recording said personal medical historical information in said personal medical calendar;
locating a symbol corresponding to one medical event of said one or more personal medical events on a medical event indicia key in said personal medical calendar;
retrieving a medical indicia applicator that corresponds to said symbol for said one medical event; and
applying said medical indicia applicator on appropriate calendar indicia on one or more sheets of said personal medical calendar that corresponds to the date of said one medical event.

19. The method of claim 18 further comprising recording daily home medical testing results pertinent to the medical condition of a user on locations within said calendar indicia on each of said one or more sheets of said personal medical calendar.
